(19) United States
(12) Patent Application Publication
(10) Pub. No.: US 2017/0052304 A1
(43) Pub. Date: Feb. 23, 2017

(54) BACKLIGHT MODULES NAD DISPLAY PANELS

(71) Applicants: Shenzhen China Star Optoelectronics Technology Co., Ltd., Shenzhen, Guangdong (CN); Wuhan China Star Optoelectronics Technology Co., Ltd., Wuhan, Hubei (CN)

(72) Inventor: Yan CHENG, Shenzhen, Guangdong (CN)

(73) Assignees: Shenzhen China Star Optoelectronics Technology Co., Ltd., Shenzhen, Guangdong (CN); WUHAN CHINA STAR OPTOELECTRONICS TECHNOLOGY CO., L TD, Wuhan, Hubei (CN)

(21) Appl. No.: 14/896,895

(22) PCT Filed: Aug. 28, 2015
(86) PCT No.: PCT/CN2015/088377

§ 371 Date: Dec. 8, 2015

(30) Foreign Application Priority Data
Aug. 21, 2015 (CN) 201510520242.8

(51) Int. Cl. F21V 8/00

(52) U.S. Cl. CPC G02B 6/0026; G02B 6/002; G02B 6/0031; G02B 6/0016

(57) ABSTRACT

The present disclosure relates to a backlight module and a display panel. The backlight module includes a light source, a QD tube and a light guiding plate, the light source being arranged at a lateral side of the light guiding plate, the QD tube being arranged between the light source and the light guiding plate. A light incident surface of the light guiding plate depresses toward an internal of the light guiding plate such that one side of the QD tube is embedded into the light guiding plate and the other side of the QD tube abuts against the light source. The structure is simple and may be easily assembled. In addition, such configuration contributes to the light and thin design.

### BACKGROUND OF THE INVENTION

1. Field of the Invention

The present disclosure relates to liquid crystal display technology, and more particularly to a backlight module and a display panel.

2. Discussion of the Related Art

Currently, backlight modules provide backlight for the liquid crystal panels. The backlight module usually include white LED operating as a light source, a light guiding plate, and optical films. The NTSC color range of the liquid crystal panel having such backlight module is around 72%. In order to provide natural color for the displayed images, i.e., to avoid distortion, the display performance having enhanced color range has been expected.

In view of the above object, quantum-dot (QD) backlight source has been developed, which adopts QD material in backlight modules. The light source of high spectrum has replaced the traditional white light LED light source. Basing on the quantum effect, when being radiated by the light source of high spectrum, light spectrum of different wavelengths may be activated. The color of the light may be adjusted by configuring the dimension of the QD material. In this way, the high color range demand may be accomplished, and thus the NTSC color range may be increased up to 100%, which greatly enhances the display performance of the liquid crystal panel.

Currently, there are two packing modes of QD backlight modules. FIG. 1 is a schematic view of one conventional backlight module. The QD tube 12 of the backlight module 100 is arranged between the light guiding plate 13 and the light source 11. The QD tube 12 is oval-shaped, and may be supported by the support 14. The structure of the backlight module 100 is complex and it is difficult to assemble the backlight module 100. In addition, the optical coupling efficiency of the backlight module 100 is low. FIG. 2 is a schematic view of another conventional backlight module. The QD material of the backlight module 200 has been coated on a surface of the sheet 22 arranged above the light guiding plate 21. When manufacturing the sheet 22, the QD material coated in a rim may lead to oxidation due to the air and the water. In addition, the configuration of the sheet may increase the thickness of the backlight module 200, and thus it is difficult to implement the narrow border and light/thin design.

### SUMMARY

The object of the invention is to overcome the problems of the conventional backlight module, such as the complicated structure, difficult assembling process, and difficult to implement the thin and light design.

In one aspect, a backlight module includes: a light source, a QD tube and a light guiding plate, the light source being arranged at a lateral side of the light guiding plate, the QD tube being arranged between the light source and the light guiding plate; a light incident surface of the light guiding plate depresses toward an internal of the light guiding plate such that one side of the QD tube being embedded into the light guiding plate and the other side of the QD tube abuts against the light source; the QD tube being configured to be elliptic cylinder, and the light incident surface of the light guiding plate being configured to be an arc surface engaging with the elliptic cylinder; and the light guiding plate includes an assembling portion and a light guiding portion, a thickness of the assembling portion being configured to be larger than the thickness of the light guiding portion, the light incident surface being configured on the assembling portion, and a top surface of the light guiding portion being the light emitting surface.

Wherein the backlight module further comprises a double-layer adhesive having a light reflective layer and a light absorption layer, the double-layer adhesive is arranged above the light source and the QD tube, and the light reflective layer faces toward the light source.

In another aspect, a backlight module includes: a light source, a QD tube and a light guiding plate, the light source being arranged at a lateral side of the light guiding plate, the QD tube being arranged between the light source and the light guiding plate; and a light incident surface of the light guiding plate depresses toward an internal of the light guiding plate such that one side of the QD tube being embedded into the light guiding plate and the other side of the QD tube abuts against the light source.

Wherein the light incident surface engages with an outer surface of one side of the QD tube.

Wherein the QD tube is configured to be elliptic cylinder, and the light incident surface of the light guiding plate is configured to be an arc surface engaging with the elliptic cylinder.

Wherein the light guiding plate comprises an assembling portion and a light guiding portion, a thickness of the assembling portion is configured to be larger than the thickness of the light guiding portion, the light incident surface is configured on the assembling portion, and a top surface of the light guiding portion being the light emitting surface.

Wherein the backlight module further comprises a double-layer adhesive having a light reflective layer and a light absorption layer, the double-layer adhesive is arranged above the light source and the QD tube, and the light reflective layer faces toward the light source.

Wherein the double-layer adhesive connects the assembling portion of the light guiding plate and the light source.

Wherein the backlight module further comprises a reflective sheet configured below a bottom of the light guiding plate.

Wherein the light incident surface comprises a plurality of optical micro-structure to uniformly distribute light beams entering the light guiding plate from the light incident surface.

Wherein the optical micro-structure is an arc-shaped recess.

In another aspect, a display panel includes: a backlight module comprising a light source, a QD tube and a light guiding plate, the light source being arranged at a lateral side of the light guiding plate, the QD tube being arranged between the light source and the light guiding plate; and a light incident surface of the light guiding plate depresses toward an internal of the light guiding plate such that one side of the QD tube being embedded into the light guiding plate and the other side of the QD tube abuts against the light source.

Wherein the light incident surface engages with an outer surface of one side of the QD tube.

Wherein the QD tube is configured to be elliptic cylinder, and the light incident surface of the light guiding plate is configured to be an arc surface engaging with the elliptic cylinder.

Wherein the light guiding plate comprises an assembling portion and a light guiding portion, a thickness of the assembling portion is configured to be larger than the thickness of the light guiding portion, the light incident surface is configured on the assembling portion, and a top surface of the light guiding portion being the light emitting surface.

Wherein the backlight module further comprises a double-layer adhesive having a light reflective layer and a light absorption layer, the double-layer adhesive is arranged above the light source and the QD tube, and the light reflective layer faces toward the light source.

Wherein the double-layer adhesive connects the assembling portion of the light guiding plate and the light source.

Wherein the backlight module further comprises a reflective sheet configured below a bottom of the light guiding plate.

Wherein the light incident surface comprises a plurality of optical micro-structure to uniformly distribute light beams entering the light guiding plate from the light incident surface.

Wherein the optical micro-structure is an arc-shaped recess.

In view of the above object, quantum-dot (QD) backlight source has been developed, which adopts QD material in backlight modules. The light source of high spectrum has replaced the traditional white light LED light source. Basing on the quantum effect, when being radiated by the light source of high spectrum, light spectrum of different wavelengths may be activated. The color of the light may be adjusted by configuring the dimension of the QD material. In this way, the high color range demand may be accomplished, and thus the NTSC color range may be increased up to 100%, which greatly enhances the display performance of the liquid crystal panel.

### BRIEF DESCRIPTION OF THE DRAWINGS

FIG. 1 is a schematic view of one conventional backlight module.

FIG. 2 is a schematic view of another conventional backlight module.

FIG. 3 is a schematic view of the backlight module in accordance with one embodiment.

FIG. 4 is a top view of the backlight module of FIG. 3.

FIG. 5 is a schematic view of two ways of embedding the QD tube into the light guiding plate of the backlight module of FIG. 3.

FIG. 6 is a schematic view of the light-guiding micro-structure on the light incident surface of the light guiding plate of the backlight module of FIG. 3.

FIG. 7 is a schematic view of the display panel in accordance with one embodiment.

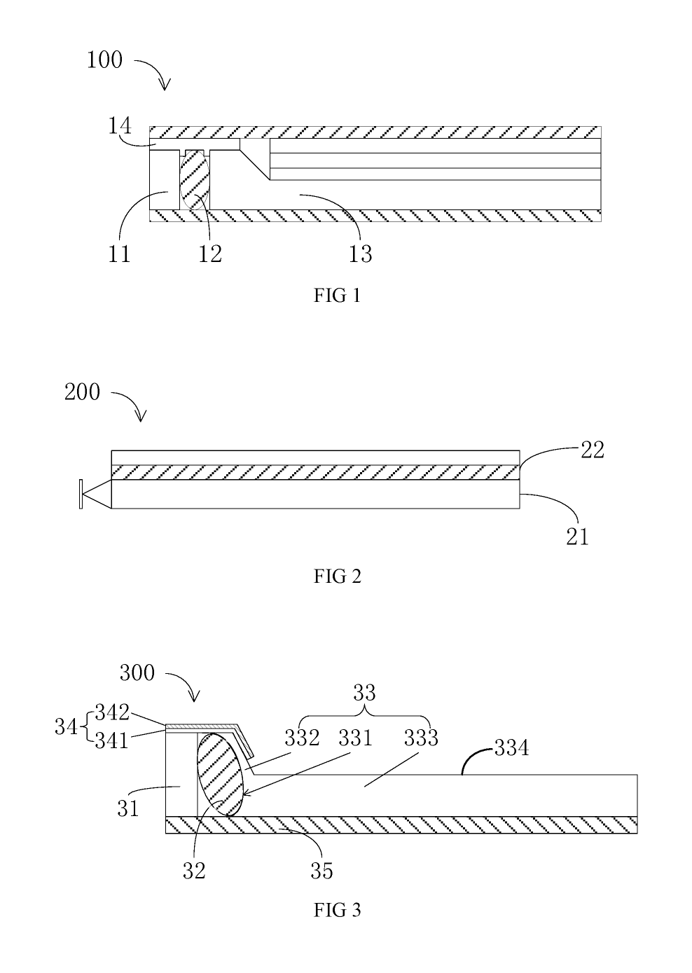

### DETAILED DESCRIPTION OF THE EMBODIMENTS

Embodiments of the invention will now be described more fully hereinafter with reference to the accompanying drawings, in which embodiments of the invention are shown.

FIG. 3 is a schematic view of the backlight module in accordance with one embodiment. FIG. 4 is a top view of the backlight module of FIG. 3.

The backlight module 300 includes a light source 31, a QD tube 32 and a light guiding plate 33. The light source 31 is arranged at a lateral side of the light guiding plate 33. The QD tube 32 is arranged between the light source 31 and the light guiding plate 33.

The operating process of the backlight module 300 for implementing the high color range requirement will be described hereinafter. The high frequency light beams emitted from the light source 31 enter the QD tube 32 such that the QD material has been activated to generate light beams of different wavelengths. The color of the light beams may be adjusted by configuring the dimension of the QD material. The integrated light beams enter the light guiding plate 33 and then emit out.

In the embodiment, the light source 31 may be blue light LED, red QD material and green QD material respectively generating pure red light and green light when being activated by the high frequency blue light. Afterward, the three original color, blue, red, and green lights are configured so as to implement a wider color range than the traditional white light LED. In other embodiments, the light source 31 may be purple LED for activating blue QD material, red QD material, and green QD material to respectively generate the three original color light. In the present disclosure, the light source 31 will be introducing taking the blue LED as one example, but it can be understood that the light source 31 is not limited to the blue LED.

In the above process, the light beams emitted by the QD tube 32 enter the light guiding plate 33 via a light incident surface 331 of the light guiding plate 33. In the embodiment, the light incident surface 331 of the light guiding plate 33 depresses toward an internal of the light guiding plate 33 such that one side of the QD tube 32 is embedded into the light guiding plate 33 and the other side of the QD tube 32 abuts against the light source 31.

One side of the QD tube 32 embedded into the light guiding plate 33 implement a multiple-dots contact or a surface contact. The other side of the tube abuts against the light source 31. In addition, the location of the light guiding plate 33 and the light source 31 are fixed. Thus, the QD tube 32 may be stably arranged between the light source 31 and the light guiding plate 33.

One side of the QD tube 32 embedded into the light guiding plate 33 implement a multiple-dots contact or a surface contact. FIG. 5 is a schematic view of two ways of embedding the QD tube into the light guiding plate of the backlight module of FIG. 3, wherein “a” relates to the contact of multiple-dots, and “b” relates to the surface contact. With respect to both of the two ways, the QD tube 32 may be stable arranged between the light source 31 and the light guiding plate 33. Regarding the surface contact, as indicated by “b”, there is no gap between the QD tube 32 and the light incident surface 331. The generated light beams directly emit into the light guiding plate 33, and thus the QD tube 32 and the light guiding plate 33 may own a higher coupling efficiency.

In the embodiment, the light incident surface 331 engages with one side of the QD tube 32 such that the QD tube 32 may be embedded into the light guiding plate 33 via surface contact. The QD tube 32 bonds on the light incident surface 331 of the light guiding plate 33 such that the QD tube 32 may be stably arranged. At the same time, the coupling efficiency of the QD tube 32 and the light guiding plate 33 may be enhanced.

In manufacturing process, in order to facilitate the mass production, the QD tube 32 is configured to be elliptic cylinder. The light incident surface 331 of the light guiding plate 33 is configured to be an arc surface for engaging with the elliptic cylinder.

In the embodiment, the light guiding plate 33 includes an assembling portion 332 and a light guiding portion 333. The light incident surface 331 is arranged on the assembling portion 332. The assembling portion 332 is configured for assembling the QD tube 32, and thus the QD tube 32 may be embedded therein. The light guiding portion 333 is configured for uniformly emit the light beams from the light guiding plate 33 via the a light emitting surface 334. The light emitting surface 334 is a top surface of the light guiding portion 333. The assembling portion 332 is not configured for emitting the light beams. Thus, when the backlight module 300 is incorporated in the liquid crystal panel, the optical films are assembled on the light emitting surface 334.

As the QD tube 32 has to be embedded into the assembling portion 332, and thus the thickness of the assembling portion 332 has to configured. The thickness of the light guiding portion 333 may not be the same with that of the assembling portion 332. In order to implement the light and thin design, the thickness of the light guiding portion 333 is configured to be smaller than the thickness of the assembling portion 332.

The assembling portion 332 and the light guiding portion 333 are only described in a simpler way. In assembling process, the assembling portion 332 and the light guiding portion 333 are two portions of the light guiding plate 33. The route of the light beams within the light guiding plate 33 is not divided into the assembling portion 332 and the light guiding portion 333.

With respect to the design of the backlight module, optical efficiency is a key issue. In the embodiment, a double-layer adhesive 34 is arranged on the light source 31 and the QD tube 32. The double-layer adhesive 34 includes a light reflective layer 341 and a light absorption layer 342. The light reflective layer 341 faces toward the light source 11.

The light reflective layer 341 may be white light reflective material for reflecting the light beams back to the QD tube 32. The light absorption layer 342 may be black light absorption material for preventing the light source 31 from the light leakage. The double-layer adhesive 34 is transformable material. Thus, the double-layer adhesive 34 may be closely bonds on tops of the light source 31 and the QD tube 32.

As the top of the assembling portion 332 may leak light, and thus in the embodiment, the double-layer adhesive 34 covers the assembling portion 332. As the thickness of the assembling portion 332 is larger than that of the light guiding portion 333, a step formed between the assembling portion 332 and the light guiding portion 333. In the manufacturing process, the optical films are arranged on the light emitting surface 334, and the double-layer adhesive 34 covers the assembling portion 332 along the step and edges of the optical films. At this moment, the double-layer adhesive 34 connects the light source 31 and the assembling portion 332 of the light guiding plate 33, which contributes to the fixation of the light source 31 and the light guiding plate 33.

As shown in FIG. 4, the double-layer adhesive 34 has not covered the light source 31. FIG. 4 only intends to describe the arrangement of the light source 31. In real scenario, the double-layer adhesive 34 covers the light source 31. As shown in FIG. 4, a distance “b” is configured to be between the blue LEDs.

In order to enhance the light efficiency, a reflective sheet 35 is configured below a bottom of the light guiding plate 33 for reflecting the light beams back to the light guiding plate 33. The reflective sheet 35 is configured to below the light source 31 and the QD tube 32 for reflecting the light beams emitted from the light source 31 and the QD tube 32.

In the embodiment, the light source 31 may be blue LED. Due to the cost and power consumption issues of the blue LED, only a few blue LEDs are configured. Under the circumstance, the gap between the blue LEDs may be increased. When the backlight module 300 is incorporated within the display panel, as the blue LED is a sphere, the light beams emitted from a center are more than that from two lateral sides. In addition, the light beams emitted from the center are stronger than that from two lateral sides. Thus, when the gap between two blue LEDs is larger, the hotspot issue, i.e., the light incident portion of the border may include alternately dark and bright strips, may occur.

In order to eliminate such issue, a plurality of optical micro-structure 335 are configured on the light incident surface 331, which contributes to the uniformly distribution of the light beams entering the light guiding plate 33 from the light incident surface 331. That is, the optical micro-structure 335 is configured for enlarging the incident angle of the light beams entering the light guiding plate 33. This reduces the dark areas and thus the light beams may be uniformly distributed.

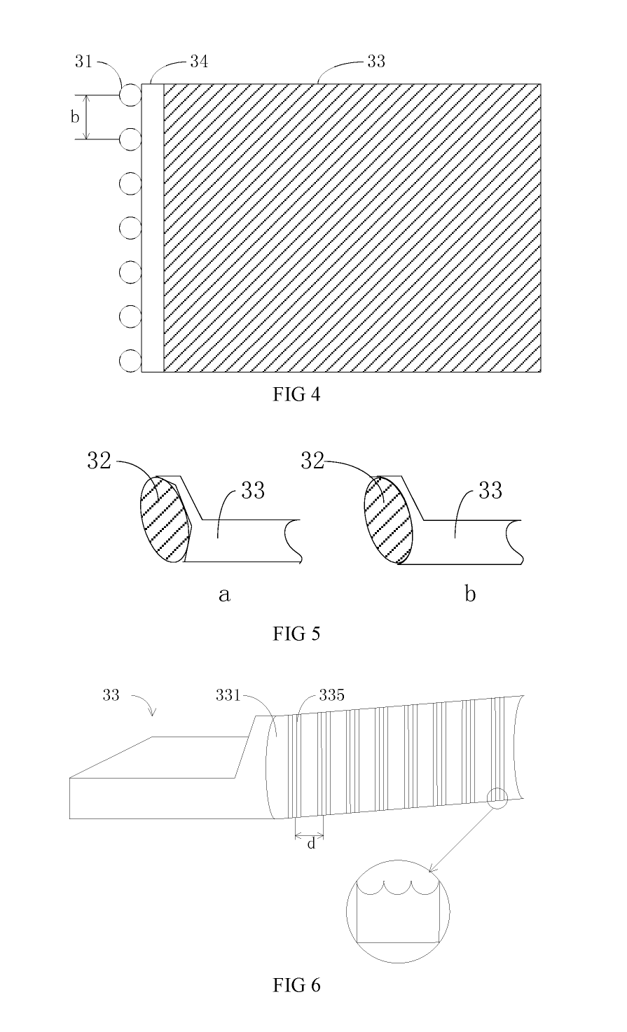

FIG. 6 is a schematic view of the light-guiding micro-structure on the light incident surface of the light guiding plate of the backlight module of FIG. 3. The optical micro-structure 335 is an arc-shaped recess. In addition, the optical micro-structure is configured for uniformly distribute the light beams from the blue LED. Thus, the optical micro-structure 335 is configured in accordance with each of the blue LED. That is, the distance between the optical micro-structure 335 (“d”) equals to the distance between two blue LEDs (“b”).

In view of the above, the backlight module includes the light source, the QD tube, and light guiding plate. The light source is arranged at a lateral side of the light guiding plate. The QD tube is arranged between the light source and the light guiding plate. The light incident surface of the light guiding plate recesses toward the internal of the light guiding plate such that one side of the QD tube is embedded into the light guiding plate. The light guiding plate contributes to the fixation of the QD tube. As such, a specific support for supporting the QD tube may be omitted. The structure is simple and may be easily assembled. In addition, such configuration contributes to the light and thin design.

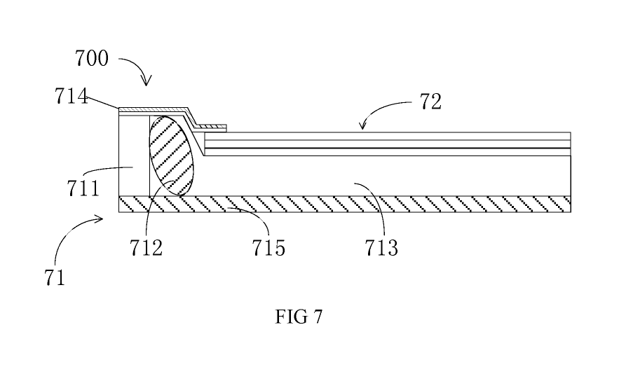

FIG. 7 is a schematic view of the display panel in accordance with one embodiment. The display panel 700 may be a large display device, such as TV. The display panel 700 may also be display devices of small size, such as phones, or watches. The display panel 700 includes a backlight module 71 and optical films 72.

The backlight module 71 includes a light source 711, a QD tube 712, a double-layers adhesive 714, and a reflective sheet 715. The double-layers adhesive 714 covers the light source 711 and the QD tube 712 and edges of the optical films 72.

The structure of the backlight module 71 is similar to that of the backlight module 300, and thus is omitted hereinafter.

Compared with the conventional technology, the display panel adopts the QD tube such that the display panel includes 100% NTSC color range. The structure is simple and may be easily assembled. In addition, such configuration contributes to the light and thin design.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A backlight module, comprising:
a light source, a QD tube and a light guiding plate, the light source being arranged at a lateral side of the light guiding plate, the QD tube being arranged between the light source and the light guiding plate;
a light incident surface of the light guiding plate depresses toward an internal of the light guiding plate such that one side of the QD tube being embedded into the light guiding plate and the other side of the QD tube abuts against the light source;
the QD tube being configured to be elliptic cylinder, and the light incident surface of the light guiding plate being configured to be an arc surface engaging with the elliptic cylinder; and
the light guiding plate includes an assembling portion and a light guiding portion, a thickness of the assembling portion being configured to be larger than the thickness of the light guiding portion, the light incident surface being configured on the assembling portion, and a top surface of the light guiding portion being the light emitting surface.

2. The backlight module as claimed in claim 1, wherein the backlight module further comprises a double-layer adhesive having a light reflective layer and a light absorption layer, the double-layer adhesive is arranged above the light source and the QD tube, and the light reflective layer faces toward the light source.

3. A backlight module, comprising:
a light source, a QD tube and a light guiding plate, the light source being arranged at a lateral side of the light guiding plate, the QD tube being arranged between the light source and the light guiding plate; and
a light incident surface of the light guiding plate depresses toward an internal of the light guiding plate such that one side of the QD tube being embedded into the light guiding plate and the other side of the QD tube abuts against the light source.

4. The backlight module as claimed in claim 3, wherein the light incident surface engages with an outer surface of one side of the QD tube.

5. The backlight module as claimed in claim 4, wherein the QD tube is configured to be elliptic cylinder, and the light incident surface of the light guiding plate is configured to be an arc surface engaging with the elliptic cylinder.

6. The backlight module as claimed in claim 4, wherein the light guiding plate comprises an assembling portion and a light guiding portion, a thickness of the assembling portion is configured to be larger than the thickness of the light guiding portion, the light incident surface is configured on the assembling portion, and a top surface of the light guiding portion being the light emitting surface.

7. The backlight module as claimed in claim 6, wherein the backlight module further comprises a double-layer adhesive having a light reflective layer and a light absorption layer, the double-layer adhesive is arranged above the light source and the QD tube, and the light reflective layer faces toward the light source.

8. The backlight module as claimed in claim 7, wherein the double-layer adhesive connects the assembling portion of the light guiding plate and the light source.

9. The backlight module as claimed in claim 3, wherein the backlight module further comprises a reflective sheet configured below a bottom of the light guiding plate.

10. The backlight module as claimed in claim 3, wherein the light incident surface comprises a plurality of optical micro-structure to uniformly distribute light beams entering the light guiding plate from the light incident surface.

11. The backlight module as claimed in claim 10, wherein the optical micro-structure is an arc-shaped recess.

12. A display panel, comprising:
a backlight module comprising a light source, a QD tube and a light guiding plate, the light source being arranged at a lateral side of the light guiding plate, the QD tube being arranged between the light source and the light guiding plate; and
a light incident surface of the light guiding plate depresses toward an internal of the light guiding plate such that one side of the QD tube being embedded into the light guiding plate and the other side of the QD tube abuts against the light source.

13. The display panel as claimed in claim 12, wherein the light incident surface engages with an outer surface of one side of the QD tube.

14. The display panel as claimed in claim 13, wherein the QD tube is configured to be elliptic cylinder, and the light incident surface of the light guiding plate is configured to be an arc surface engaging with the elliptic cylinder.

15. The display panel as claimed in claim 13, wherein the light guiding plate comprises an assembling portion and a light guiding portion, a thickness of the assembling portion is configured to be larger than the thickness of the light guiding portion, the light incident surface is configured on the assembling portion, and a top surface of the light guiding portion being the light emitting surface.

16. The display panel as claimed in claim 15, wherein the backlight module further comprises a double-layer adhesive having a light reflective layer and a light absorption layer, the double-layer adhesive is arranged above the light source and the QD tube, and the light reflective layer faces toward the light source.

17. The display panel as claimed in claim 16, wherein the double-layer adhesive connects the assembling portion of the light guiding plate and the light source.

18. The display panel as claimed in claim 12, wherein the backlight module further comprises a reflective sheet configured below a bottom of the light guiding plate.

19. The display panel as claimed in claim 12, wherein the light incident surface comprises a plurality of optical micro-structure to uniformly distribute light beams entering the light guiding plate from the light incident surface.

20. The display panel as claimed in claim 19, wherein the optical micro-structure is an arc-shaped recess.
